(19) United States
(12) Patent Application Publication
(10) Pub. No.: US 2025/0357021 A1
(43) Pub. Date: Nov. 20, 2025

(54) COAXIAL CABLE FOR NUCLEAR POWER PLANT

(71) Applicant: LS CABLE & SYSTEM LTD., Anyang-si, Gyeonggi-do (KR)

(72) Inventor: Jae Hoon LEE, Yeonsu-gu, Incheon (KR)

(21) Appl. No.: 18/876,565

(22) PCT Filed: Jul. 13, 2022
(86) PCT No.: PCT/KR2022/010187

§ 371 Date: Dec. 18, 2024

(30) Foreign Application Priority Data
Jun. 30, 2022 (KR) 10-2022-0080296

(51) Int. Cl. H01B 7/28; G21D 1/00; H01B 3/44; H01B 7/29

(52) U.S. Cl. CPC H01B 7/2813; H01B 7/292; G21D 1/00; H01B 3/441

(57) ABSTRACT

The present disclosure relates to a coaxial cable for nuclear power plants, and more specifically, relates to a coaxial cable for nuclear power plants, which includes an inner conductor arranged at a center of a cable, an insulating layer arranged in a form of surrounding an outer periphery of the inner conductor, and formed of a foaming material forming many porous cells, and a sheath layer arranged in a form of surrounding an outer periphery of the insulating layer. Activation energy of the insulating layer is within a range of 2.06 eV to 2.84 eV. Accordingly, it is possible to provide the coaxial cable for nuclear power plants which can maintain a certain level of performance even after the elapse of a specified lifespan.

### CROSS-REFERENCE TO RELATED APPLICATIONS

The present application is a National Stage of International Application No. PCT/KR2022/010187, filed on Jul. 13, 2022, which claims priority to Korean Application No. 10-2022-0080296, filed Jun. 30, 2022, the entire contents of each hereby incorporated by reference.

### FIELD

The present disclosure relates to a coaxial cable for nuclear power plants, and more specifically, relates to a coaxial cable for nuclear power plants which can maintain a certain level of performance to be applicable to nuclear power plants.

### BACKGROUND

In various types of cables, cables for nuclear power plants are laid in various facilities inside nuclear power plants, and are used to transmit power and various control signals.

The cables for the nuclear power plants require physical and chemical characteristics which are different from those of general cables due to a usage environment where the cables are continuously exposed to gamma rays having high penetrability and destructive power in radiations.

Typically, the cables for the nuclear power plants are subjected to reliability tests in view of a long-term operation for several decades or a longer time. A containment chamber where a nuclear reactor is in operation is always maintained in a high-temperature atmosphere, and a temperature for continuous operations reaches 90°. The containment chamber creates a much harsher temperature environment than an environment in which cables formed of a general polymer material are used.

Moreover, the nuclear reactor is subjected to simulation for a coolant loss accident which is a worst-case scenario. With regard to the accident, the coolant of the nuclear reactor leaks. Consequently, the cables are temporarily exposed to a large amount of radiation, and are momentarily exposed to an extremely high-temperature and high-pressure environment. Moreover, the cables has to withstand even a virtual test in which a large amount of chemicals is sprayed.

This process is important due to the following reason. When cables connecting various control devices are damaged without withstanding the virtual accident, the nuclear reactor may be damaged in a state where a process for minimizing own accident damage of the nuclear power plant is not completed. Consequently, there may be a worst-case scenario in which radiation may leak into a surrounding area.

As a result, radiation resistance, heat resistance, chemical resistance, and long-term reliability are important product design criteria of the cables for the nuclear power plants. Therefore, it is preferable to develop cables for nuclear power plants these which are suitable for the product design criteria.

### PRIOR ART DOCUMENT

### Patent Document

Korean Patent No. 10-2011-0060133 (Jun. 8, 2011)

### SUMMARY

In order to solve the above-described problems, a technical object to be achieved by the present disclosure is to propose a coaxial cable for nuclear power plants in which an insulator having a certain or higher level of activation energy is applied to the cable so that communication characteristics can be maintained even after the elapse of a specified lifespan.

Solutions of the present disclosure are not limited to those described above, and other solutions which are not described herein will be clearly understood by those skilled in the art from the description below.

As means for achieving the technical object, there is provided a coaxial cable for nuclear power plants which includes an inner conductor arranged at a center of a cable, an insulating layer arranged in a form of surrounding an outer periphery of the inner conductor, and formed of a foaming material forming many porous cells, and a sheath layer arranged in a form of surrounding an outer periphery of the insulating layer. Activation energy of the insulating layer is within a range of 2.06 eV to 2.84 eV.

In addition, in the coaxial cable for nuclear power plants according to the present disclosure, a foam degree of the insulating layer may be 79% to 93%.

In addition, in the coaxial cable for nuclear power plants according to the present disclosure, a relative dielectric constant of the insulating layer may be within a range of 1.1 to 1.29.

In addition, in the coaxial cable for nuclear power plants according to the present disclosure, a signal propagation speed of the cable may be within a range of 88% to 96% of a signal propagation speed in air.

In addition, the coaxial cable for nuclear power plants according to the present disclosure may further include an inner skin layer interposed between the inner conductor and the insulating layer, an outer conductor formed to surround the outer periphery of the insulating layer, and an outer skin layer interposed between the insulating layer and the outer conductor.

In addition, in the coaxial cable for nuclear power plants according to the present disclosure, the insulating layer may be any one of high density polyethylene (HDPE), low density polyethylene (LDPE), and a mixture of the high density polyethylene and the low density polyethylene.

In addition, in the coaxial cable for nuclear power plants according to the present disclosure, a mixing ratio of the mixture of the high density polyethylene (HDPE) and the low density polyethylene (LDPE) may be within a range of 6:4 to 8:2.

In addition, in the coaxial cable for nuclear power plants according to the present disclosure, a relative dielectric constant of the high density polyethylene (HDPE) may be 1.99 to 2.69, a melt flow index of the high density polyethylene (HDPE) at 190° C. may be 6.8 g/10 min to 9.2 g/10 min, a relative dielectric constant of the low density polyethylene (LDPE) may be 1.93 to 2.61, and a melt flow index the low density polyethylene (LDPE) at 190° C. may be 5.1 g/10 min to 6.9 g/10 min.

In addition, in the coaxial cable for nuclear power plants according to the present disclosure, insulation resistance of the cable may be 1 MΩ or higher after radiation aging of 70 Mrad is performed on the cable.

In addition, in the coaxial cable for nuclear power plants according to the present disclosure, the insulation resistance of the cable after accelerated thermal aging equivalent to at least 20 years is performed on the cable may be 1 MΩ or higher.

In addition, in the coaxial cable for nuclear power plants according to the present disclosure, the insulation resistance of the cable after a bending test is performed so that the cable is bent to be smaller than 20 times a diameter of the cable and unfolded again may be 1 MΩ or higher.

In addition, in the coaxial cable for nuclear power plants according to the present disclosure, the insulation resistance of the cable after a voltage of 2.5 kVdc is applied for 5 minutes after the cable is immersed for one hour may be 1 MΩ or higher.

In addition, in the coaxial cable for nuclear power plants according to the present disclosure, a relative dielectric constant of the cable may be maintained at a change rate ±10% compared to a non-aged cable, and a signal propagation speed may be maintained at a change rate ±10% compared to the non-aged cable.

According to the present disclosure, an insulator having activation energy equal to or higher than a certain level is applied to the cable. Therefore, the present disclosure has an advantageous effect of providing a coaxial cable for nuclear power plants which can maintain communication characteristics even after the elapse of a specified lifespan.

In addition, the present disclosure has an advantageous effect of providing a coaxial cable for nuclear power plants which can improve a propagation speed of a signal transmitted to the cable in such a manner that the insulating layer of the cable is formed of a foaming material to reduce a dielectric constant of the insulating layer.

The advantageous effects of the present disclosure are not limited to those described above, and other advantageous effects which are not described herein will be clearly understood by those skilled in the art from the description below.

### BRIEF DESCRIPTION OF THE DRAWING

The accompanying drawings are intended to more specifically describe the contents of the present disclosure to a person skilled in the art, but the technical ideas of the present disclosure are not limited thereto.

FIG. 1 is a cross-sectional view of a coaxial cable for nuclear power plants according to a preferred embodiment of the present disclosure.

FIG. 2 is a cross-sectional view of a coaxial cable for nuclear power plants according to another preferred embodiment of the present disclosure.

FIGS. 3a and 3b are graphs for describing activation energy of the coaxial cable for nuclear power plants according to the preferred embodiment of the present disclosure.

### DETAILED DESCRIPTION

Objects, other objects, features, and advantages of the present disclosure will be readily understood through the following preferred embodiments related to the accompanying drawings. However, the present disclosure is not limited to the embodiments described herein, and may be embodied in other forms. Meanwhile, the embodiments introduced herein are provided so that the concept of the present disclosure can be sufficiently delivered to those skilled in the art to allow the disclosed contents to be thorough and complete.

In this specification, when it is described that a component exists on another component, it means that a component may be directly formed on another component, or a third component may be interposed therebetween. In addition, in the drawings, thicknesses of components are exaggerated to effectively described the technical contents.

When an element, a component, a device, or a system is referred to as including a component having a program or software, even when there is no explicit description, it should be understood that the element, the component, the device, or the system includes hardware (for example, a memory, a CPU, and the like), other programs, or other software (for example, an operating system, a driver required for operating the hardware, and the like) required for executing or operating the program or the software.

In addition, unless otherwise specifically stated, when an element (or a component) is implemented, it should be understood that the element (or the component) may be implemented in a form of software, hardware, or both software and hardware.

In addition, terms are used in this specification only to described embodiments, and are not intended to limit the present disclosure. In this specification, a singular form also includes a plural form unless otherwise specifically stated. A component in the terms “comprises” and/or “comprising” as used in this specification does not exclude the presence or addition of one or more other components.

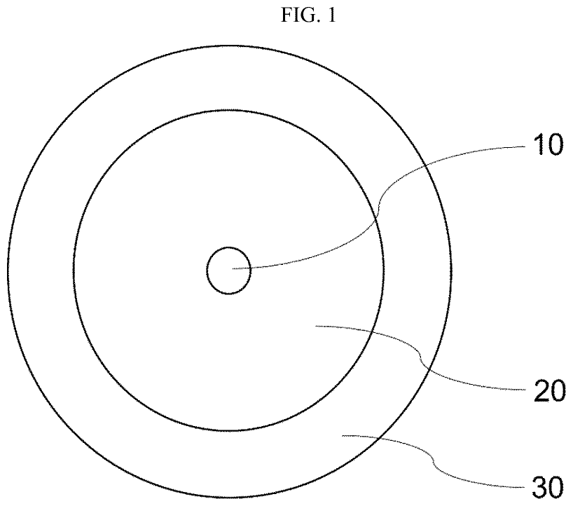

FIG. 1 is a cross-sectional view of a coaxial cable for nuclear power plants according to a preferred embodiment of the present disclosure.

Referring to FIG. 1, the coaxial cable for nuclear power plants according to the preferred embodiment of the present disclosure will be described. As illustrated, the coaxial cable for nuclear power plants includes an inner conductor (10), an insulating layer (20), and a sheath layer (30).

The inner conductor (10) is a portion located at a center of the cable to transmit a signal. For this purpose, as the inner conductor (10), a conductor formed of a metal material that facilitates transmission of high-frequency signals is adopted.

For example, the conductor formed of the metal material may be formed of any single metal in copper, aluminum, iron, and nickel, or may be formed of two or more metal alloys. In addition, in some cases, the conductor may be in a form in which one metal is plated with another metal. In a case of the alloy, it is preferable to use a copper alloy plated with copper or another metal.

When the metal material is copper, it is preferable to use a oxygen-free copper wire having no oxygen content. When the oxygen-free copper wire is used, there is an advantage of improving an electrical transmission rate.

In addition, when the metal material is a copper alloy plated with another metal, it is preferable to use a tin-plated oxygen-free copper wire or a silver-plated oxygen-free copper wire in which a tin-plated layer or a silver-plated layer is formed on an outer peripheral surface of the oxygen-free copper wire described above. When the tin-plated layer or the silver-plated layer is formed on the oxygen-free copper wire, oxidation of the conductor may be suppressed to prevent discoloration of the conductor.

Meanwhile, the inner conductor (10) may be formed into a hollow shape to improve flexibility of the cable, and may be formed into various sizes.

The insulating layer (20) is formed in a form of surrounding the inner conductor (10) around an outer periphery of the inner conductor (10), and is an element including a polymer insulating material. As the insulating layer (20), any one of low density polyethylene (LDPE), high density polyethylene (HDPE), and a mixture of the low density polyethylene and the high density polyethylene may be used. Here, a mixing ratio (HDPE:LDPE) of the high density polyethylene and the low density polyethylene may be within a range of 6:4 to 8:2. In addition, a relative dielectric constant of the high density polyethylene (HDPE) may be 1.99 to 2.69, and a melt flow index at 190° C. may be 6.8 g/10 min to 9.2 g/10 min. The relative dielectric constant of the low density polyethylene (LDPE) may be 1.93 to 2.61, and the melt flow index at 190° C. may be 5.1 g/10 min to 6.9 g/10 min.

More specifically, the insulating layer (20) is formed of a foam material forming a plurality of porous cells. As a dielectric constant of the insulating layer (20) is lower, a propagation speed of a signal transmitted to the cable increases. In this case, in order to improve the propagation speed of the signal transmitted through the cable, the dielectric constant of the insulating layer (20) has to be reduced, and the dielectric constant of the insulating layer (20) may be reduced by raising a foam degree of a foam to lower foam density. Here, the foam degree refers to a ratio of air per unit volume in the foam.

When the foam degree of the insulating layer (20) is high, the relative dielectric constant is lowered, and the propagation speed increases. Accordingly, the propagation speed of the cable tends to decrease, compared to the propagation speed in the air in a sample having a high relative dielectric constant. In addition, when the foam degree of the insulating layer (20) is excessively high, the relative dielectric constant is lowered, but the insulating layer exhibits weak characteristics in a subsequent accelerated thermal aging test and a bending test. That is, when the foam degree is excessively high, physical stability of the insulating layer (20) may be degraded, and insulation resistance may be reduced. Accordingly, it is necessary to maintain a proper foam degree, and the insulating layer (20) of the coaxial cable for nuclear power plants according to the present disclosure may be formed to have the foam degree within a range of 79% to 93%. As the foam degree of the insulating layer (20) increases, the relative dielectric constant is reduced, and the propagation speed increases. In the present embodiment, the relative dielectric constant of the insulating layer (20) may be within a range of 1.1 to 1.29.

The sheath layer (30) is formed in an outermost portion of the coaxial cable for nuclear power plants, and is arranged in a form of surrounding the outer periphery of the insulating layer (20). Depending on situations, the sheath layer (30) may be formed of various materials, and for example, may be formed of a composition containing a polyethylene-based resin or a polyolefin-based resin as a basic resin.

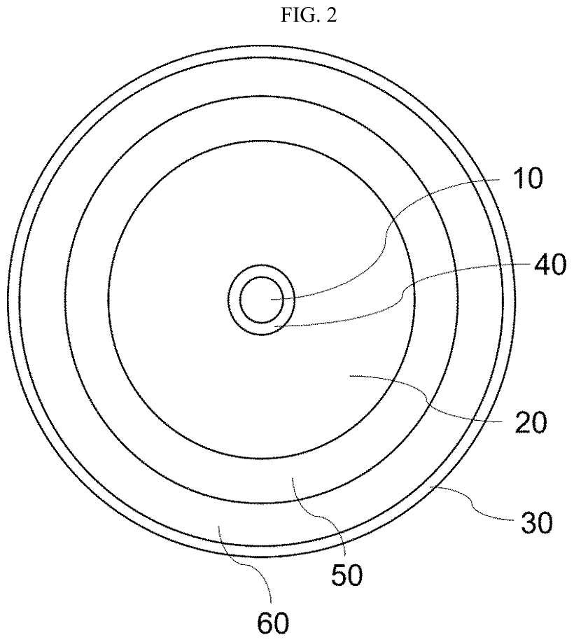

FIG. 2 is a cross-sectional view of a coaxial cable for nuclear power plants according to another preferred embodiment of the present disclosure.

FIG. 1 illustrates a cross section of the coaxial cable for nuclear power plants having a simple structure in which the inner conductor (10), the insulating layer (20), and the sheath layer (30) are stacked. However, the present embodiment illustrates a cross section of the coaxial cable for nuclear power plants in which an inner skin layer (40), an outer skin layer (50), and an outer conductor (60) are further included in addition to the inner conductor (10), the insulating layer (20), and the sheath layer (30). Since the inner conductor (10), the insulating layer (20), and the sheath layer (30) are the same as those in the previous embodiment, description thereof will be omitted.

The inner skin layer (40) is a thin film coating layer interposed between the inner conductor (10) and the insulating layer (20) to increase interfacial adhesion. Preferably, the inner skin layer (40) may contain a polymer material similar to that of the insulating layer (20).

The inner skin layer (40) may adopt a polymer resin which may minimize influence of dielectric properties of the insulating layer (20) and may provide interface properties without self-adhesive properties. When a material of the insulating layer (20) is a polyethylene-based resin, as the polymer resin to be applied to the inner skin layer (40), it is preferable to adopt a polyolefin-based resin having excellent compatibility.

Here, the polyethylene resin may be a single material or a blend of two or more polymers selected from high density polyethylene (HDPE), medium density polyethylene (MDPD), low density polyethylene (LDPE), and linear low density polyethylene. In addition, the polyolefin resin is a blend of polymers including polyethylene, polypropylene, and polyisobutylene.

The outer skin layer (50) is interposed between the insulating layer (20) and the sheath layer (30), and corresponds to an over-foaming suppression layer that suppresses over-foaming of the insulating layer (20) or bursting characteristics of foam cells provided in the insulating layer (20).

When the material of the insulating layer (20) is a polyethylene-based resin, the outer skin layer (50) may optionally be formed of polyethylene, polypropylene, and polyethylene terephthalate or a mixture thereof.

The outer conductor (60) is formed on the outer periphery of the outer skin layer (50). The outer conductor (60) is an element preventing a signal flowing in the inner conductor (10) from leaking outward of the cable, and operated to block interference such as electromagnetic waves from the outside. The outer conductor (60) may be formed of various metal materials, and in particular, may be formed of copper or an alloy containing copper having excellent conductivity and corrosion resistance. Preferably, the outer conductor (60) may be formed in a form of a corrugated pipe having a constant pitch to secure flexibility of the cable, and may be formed as a cylindrical pipe separated at an equal interval from the inner conductor (10).

According to this structure, the insulating layer (20) is located between the inner conductor (10) and the outer conductor (60), and maintains a gap between the inner conductor (10) and the outer conductor (60) while serving to insulate between the inner conductor (10) and the outer conductor (60). In addition, the insulating layer (20) has a characteristic impedance formed between the inner conductor (10) and the outer conductor (60) by the dielectric constant of the insulating layer (20), and the propagation speed of the signal transmitted to the cable may be determined by this characteristic impedance.

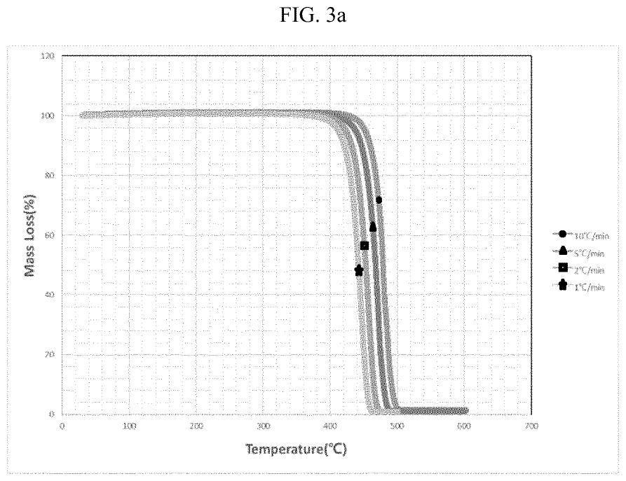

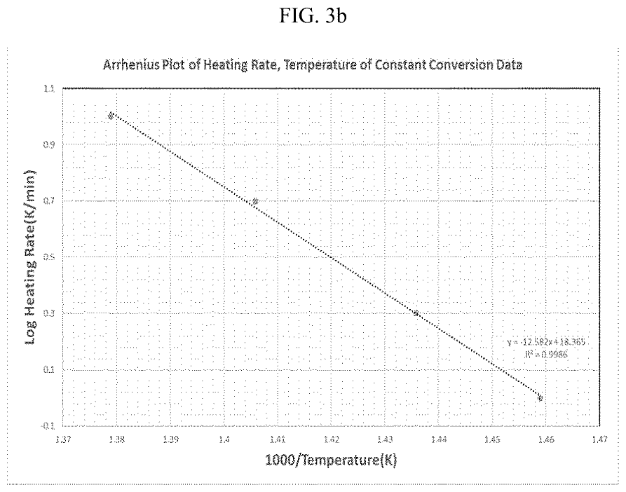

FIGS. 3a and 3b are graphs for describing the activation energy of the coaxial cable for nuclear power plants according to a preferred embodiment of the present disclosure.

The activation energy refers to minimum energy required for proceeding a chemical reaction. As the activation energy is lower, a reaction rate is faster, and as the activation energy is higher, the reaction rate is slower.

The activation energy of the coaxial cable for nuclear power plants according to the present disclosure may be calculated according to standards of ASTM E1641-07, and either a Flynn-Wall-Ozawa method or a Kissinger method may be used. The activation energy respectively calculated by the Flynn-Wall-Ozawa method and the Kissinger method does not have a significant difference in results except for a difference in interpretation methods. Therefore, any method of the two method may be used without any special restrictions.

In one example, when the activation energy is calculated by using the Flynn-Wall-Ozawa method, the activation energy is calculated, based on a temperature at which the activation energy reaches a reference change rate when an initial mass is set to 100 and a final mass is set to 0. In this case, it is assumed that decomposition occurs according to first-order kinetics, and the activation energy is calculated, based on an initial reaction, regardless of a reaction order.

In another example, when the activation energy is calculated by using the Kissinger method, the activation energy is calculated, based on a temperature at a steepest point of a slope on a graph where the material decomposes and the mass decreases due to heating. Here, when multiple orders of reactions occur, the activation energy is determined, based on the order of a fastest reaction rate.

FIG. 3a is a graph illustrating test results obtained after a thermal decomposition operation is performed by using TGA. When the thermal decomposition operation is performed by using TGA, a heating rate is changed within a range of 1° C./min to 10° C./min. The heating rate is changed at least four times, and in the present embodiment, the heating rate is changed to 1° C./min, 2° C./min, 5° C./min, and 10° C./min.

In the illustrated graph, an x-axis represents a temperature, and a y-axis represents a mass loss. This graph illustrates that the material decomposes and the mass decreases due to the heating.

Referring to these graphs, when the activation energy for the coaxial cable for nuclear power plants is calculated, the Kissinger method may be applied to calculate the activation energy, based on the temperature at the steepest point of the slope on the graph. When multiple orders of reactions occur, the activation energy is determined, based on the order of the fastest reaction rate.

FIG. 3b is a graph for calculating the activation energy by applying the Flynn-Wall-Ozawa method. In the graph, the x-axis represents a temperature, and the y-axis represents a change rate (Log Heating Rate) depending on a heating temperature. The activation energy is calculated by the slope of the graph illustrated in the present embodiment.

The activation energy of the coaxial cable for nuclear power plants may be calculated in the above-described form, and the insulating layer (20) of the coaxial cable for nuclear power plants has the activation energy within a range of 2.06 eV to 2.84 eV.

When the activation energy is lower than 2.06 eV, cable characteristics after accelerated aging may tend to be significantly changed, compared to an unaged cable. That is, a change rate in the relative dielectric constant and the signal propagation speed may be high after the accelerated aging. Consequently, original communication characteristics may not be maintained. Meanwhile, when the activation energy is high to exceed 2.84 eV, the foam degree may be low. The reason is that the activation energy is high and more energy is required during a foaming process. Therefore, in order to raise the foam degree, a flux needs to be lowered, or work needs to be carried out at a higher temperature. Accordingly, there is the following problem. Work efficiency is degraded, the relative dielectric constant is high due to the low foam degree, and the propagation speed in the cable is low, compared to the propagation speed in the air.

The activation energy may vary depending on a type, a mixing ratio, physical properties, or the like of the composition forming the insulating layer (20). According to one embodiment of the present disclosure, in the insulating layer (20), high density polyethylene and low density polyethylene may be mixed within a mixing ratio (HDPE:LDPE) of 6:4 to 8:2, the relative dielectric constant of high density polyethylene (HDPE) may be 1.99 to 2.69, the melt flow index at 190° C. may be 6.8 g/10 min to 9.2 g/10 min, the relative dielectric constant of low density polyethylene (LDPE) may be 1.93 to 2.61, and the melt flow index at 190° C. may be 5.1 g/10 min to 6.9 g/10 min.

In order to evaluate characteristics of the coaxial cables for nuclear power plants according to the present disclosure, the cables are manufactured with mutually different mixing ratios of low density polyethylene and high density polyethylene of the insulating layer (20) forming the cable and with mutually different ranges of molecular weights, and the cable characteristics are measured through a non-aged cable characteristic test and an aging cable characteristic test. Results are illustrated in Table 1 below:

TABLE 1

| | Characteristic | | Sample No. | | | | | | | |
|---|---|---|---|---|---|---|---|---|---|---|
| | Test | Spec. | #1 | #2 | #3 | #4 | #5 | #6 | #7 | #8 |
| Non- | A | Reference | 55:45 | 55:45 | 60:40 | 60:40 | 80:20 | 80:20 | 85:15 | 85:15 |
| Aged | | Value | | | | | | | | |
| Cable | B | 78~94% | 96.1 | 95.2 | 93.8 | 92.8 | 79.2 | 78.5 | 76.5 | 75.9 |
| Charac- | C | Reference | 1.91 | 2.11 | 1.94 | 2.06 | 2.83 | 2.89 | 2.98 | 2.91 |
| teristics | | Value | | | | | | | | |
| | D | 1.08~1.28 | 1.045 | 1.033 | 1.091 | 1.105 | 1.288 | 1.31 | 1.361 | 1.382 |
| | E | 88~96% | 98.1% | 96.8% | 96.2% | 95.8% | 88.3% | 80.4% | 80.9% | 82.1% |
| | F | 1MΩ | >66 | >66 | >66 | >66 | >66 | >66 | >66 | >66 |
| | | or | GΩ | GΩ | GΩ | GΩ | GΩ | GΩ | GΩ | GΩ |
| | | higher | | | | | | | | |
| Aged | G | No | No | No | No | No | No | No | No | No |
| Cable | | crack | crack | crack | crack | crack | crack | crack | crack | crack |
| Charac- | H | 1MΩ | >66 | >66 | >66 | >66 | >66 | >66 | >66 | >66 |
| teristics | | or | GΩ | GΩ | GΩ | GΩ | GΩ | GΩ | GΩ | GΩ |
| | | higher | | | | | | | | |
| | I | No | No | No | No | No | No | No | No | No |
| | | crack | crack | crack | crack | crack | crack | crack | crack | crack |
| | J | 1MΩ | >66 | >66 | >66 | >66 | >66 | >66 | >66 | >66 |
| | | or | GΩ | GΩ | GΩ | GΩ | GΩ | GΩ | GΩ | GΩ |
| | | higher | | | | | | | | |
| | K | No | No | No | No | No | No | No | No | No |
| | | crack | crack | crack | crack | crack | crack | crack | crack | crack |
| | L | 1MΩ | 67MΩ | 105 | >66 | >66 | >66 | >66 | >66 | >66 |
| | | or | | MΩ | GΩ | GΩ | GΩ | GΩ | GΩ | GΩ |
| | | higher | | | | | | | | |
| | M | No | Pass | Pass | Pass | Pass | Pass | Pass | Pass | Pass |
| | | break | | | | | | | | |
| | | down | | | | | | | | |
| | N | ±10% | −30.8% | −34.1% | −12.1% | −8.5% | −6.6% | −6.1% | −5.1% | −5.8% |
| | O | ±10% | −21.8% | −26.2% | −11.5% | −9.1% | −6.8% | −6.4% | −6.1% | −6.0% |

| | | | | | | | | |
|---|---|---|---|---|---|---|---|---|
| Final Result | Fail | Fail | Fail | Pass | Pass | Fail | Fail | Fail |

Items listed in columns of the characteristic tests in Table 1 above are as follows. A corresponds to a ratio of HDPE:LDPE, B corresponds to a foam degree, C corresponds to activation energy (eV) of the insulating layer, D corresponds to a relative dielectric constant, E corresponds to a rate of a signal propagation speed of the cable, compared to a signal propagation speed in the air, F corresponds to insulation resistance (500 Vdc, based on 1 min), G corresponds to a radiation aging test (70 Mrad), H corresponds to insulation resistance (500 Vdc, based on 1 min), I corresponds to an accelerated thermal aging test (lifespan for 20 years, 70° C.), J corresponds to insulation resistance (500 Vdc, based on 1 min), K corresponds to a bending test (based on 20D), L corresponds to insulation resistance (500 Vdc, based on 1 min), M corresponds to a immersion withstand voltage test (immersion for 1 hour or longer, 2.5 kVdc, and based on 5 minutes), N corresponds to a change rate in the relative dielectric constant, compared to the non-aged cable, and O corresponds to a change rate in signal propagation speed, compared to the non-aged cable.

As illustrated in Table 1 above, the present applicant measures non-aged cable characteristics and aged cable characteristics for eight samples, that is #1 to #8, in which the mixing ratios of HDPE and LDPE are different from each other and the ranges of the molecular weights of HDPE and LDPE are set to be different from each other. The foam degree of the insulating layer (20) is set to be within a range of 79% to 93%.

The aged cable characteristics are data measured by primarily performing the radiation aging test on the same cable sample as the cable in the non-aged cable characteristic test, by secondarily performing the accelerated thermal aging test, and by thirdly performing the bending test.

More specifically, the insulation resistance is measured after the radiation aging test is performed on samples #1 to #8, the insulation resistance is measured after the accelerated thermal aging test is performed on the samples subjected to the radiation aging test, and the insulation resistance, the immersion withstand voltage test, the change rate in the relative dielectric constant, and the change rate in the signal propagation speed are measured after the bending test is performed on the samples subjected to the radiation aging test and the accelerated thermal aging test.

HDPE in the insulating layer (20) serves as a structural member of the foam insulation. In addition, as the content of LDPE is higher in the insulating layer (20), the foam degree tends to be higher. When the foam degree is high, the relative dielectric constant is lowered, and the propagation speed increases. Accordingly, in the sample having a high relative dielectric constant, the propagation speed of the cable tends to be reduced, compared to the propagation speed in the air.

However, when the foam degree is excessively high, the relative dielectric constant is lowered, but the cable may be vulnerable to subsequent accelerated thermal aging tests and bending tests. That is, when the foam degree is excessively high, physical stability is degraded. As a result, when the foam degree is excessively high, the insulation resistance is relatively reduced.

When the activation energy is high (2.06 eV or higher), a change in the relative dielectric constant and communication characteristics which are characteristics after aging tends to be low. Therefore, the samples #4 to #8 having the activation energy of 2.06 eV or higher show a low change rate in the communication characteristics after accelerated aging. On the other hand, the samples #1 to #3 having the activation energy lower than 2.06 eV show a high change rate in the characteristics after aging.

In a case of the sample #2 having the activation energy of 2.11 eV which is higher than 2.06 eV, the communication characteristics after aging are reversely reduced. The reason is that a structure of the foam is damaged due to a high foam degree during a process of the bending after the accelerated thermal aging.

When the samples #5 and #6 are compared with each other, there is a phenomenon in which the sample #6 having higher activation energy shows a lower foam degree even though ratios of HDPE and LDPE are the same. The reason is that the activation energy of the insulating layer (20) is high and more energy is required during a foaming process. In order to further raise the foam degree, a flux needs to be lowered, or the work needs to be carried out at a higher temperature.

When the activation energy is high to exceed 2.83 eV as in the samples #6 to #8, the foam degree is low. Accordingly, since more energy is required to raise the foam degree, the flux needs to be lowered, or the work needs to be carried out at a higher temperature. This case results in degradation of work efficiency, thereby causing a problem in that the relative dielectric constant is high due to the low foam degree, and the propagation speed of the cable is lower, compared to the propagation speed in the air.

Results satisfying all tests are confirmed in the samples #4 and #5. The activation energy of the sample #4 is 2.06 eV, and the activation energy of the sample #5 is 2.83 eV. Based on test results of other samples, it is confirmed that a final result is not satisfactory when the results beyond a range of the activation energy of the samples #4 and #5.

As a result, the insulation resistance of the cable is equal to or higher than 1 MΩ even after a process of the radiation aging of 70 Mrad. In addition, the insulation resistance is equal to or higher than 1 MΩ even after a process of the accelerated thermal aging corresponding to at least 20 years. In addition, no abnormality occurs in an appearance even after a process of the bending test in which the cable is bent less than 20 times the diameter and is straightened again. In addition, the insulation is not destroyed even when the cable is immersed in tap water at a room temperature for one hour and a voltage of 2.5 kVdc is applied for 5 minutes, and the insulation resistance thereafter is equal to or higher than 1 MΩ. In addition, it is confirmed that the relative dielectric constant of the aged cable maintains a change rate of ±10% compared to the non-aged cable, and the signal propagation speed maintains a change rate of ±10% compared to the non-aged cable.

Through various tests performed in this way, it is verified that the coaxial cable for nuclear power plants according to the present disclosure may maintain a certain level of performance even after the elapse of a specified lifespan.

Those skilled in the art to which the present disclosure belongs will understand that the present disclosure can be implemented in other specific forms without changing the technical idea or the essential characteristics. Therefore, it should be understood that the embodiments described above are illustrative in all respects and not restrictive. The scope of the present disclosure is indicated by the appended claims rather than the detailed description above, and all changes or modifications derived from the meaning and the scope of the appended claims and their equivalent concepts should be interpreted as being included in the scope of the present disclosure.

### DESCRIPTION OF REFERENCE NUMERALS

10: inner conductor
20: insulating layer
30: sheath layer
40: inner skin layer
50: outer skin layer
60: outer conductor

1. A coaxial cable for nuclear power plants, comprising:
an inner conductor arranged at a center of a cable;
an insulating layer arranged in a form of surrounding an outer periphery of the inner conductor, and formed of a foaming material forming many porous cells; and
a sheath layer arranged in a form of surrounding an outer periphery of the insulating layer,
wherein activation energy of the insulating layer is within a range of 2.06 eV to 2.84 eV.

2. The coaxial cable for nuclear power plants of claim 1, wherein a foam degree of the insulating layer is 79% to 93%.

3. The coaxial cable for nuclear power plants of claim 1, wherein a relative dielectric constant of the insulating layer is within a range of 1.1 to 1.29.

4. The coaxial cable for nuclear power plants of claim 1, wherein a signal propagation speed of the cable is within a range of 88% to 96% of a signal propagation speed in air.

5. The coaxial cable for nuclear power plants of claim 1, further comprising:
an inner skin layer interposed between the inner conductor and the insulating layer;
an outer conductor formed to surround the outer periphery of the insulating layer; and
an outer skin layer interposed between the insulating layer and the outer conductor.

6. The coaxial cable for nuclear power plants of claim 1, wherein the insulating layer is any one of high density polyethylene (HDPE), low density polyethylene (LDPE), and a mixture of the high density polyethylene and the low density polyethylene.

7. The coaxial cable for nuclear power plants of claim 6, wherein a mixing ratio of the mixture of the high density polyethylene (HDPE) and the low density polyethylene (LDPE) is within a range of 6:4 to 8:2.

8. The coaxial cable for nuclear power plants of claim 7, wherein a relative dielectric constant of the high density polyethylene (HDPE) is 1.99 to 2.69, a melt flow index of the high density polyethylene (HDPE) at 190° C. is 6.8 g/10 min to 9.2 g/10 min, a relative dielectric constant of the low density polyethylene (LDPE) is 1.93 to 2.61, and a melt flow index the low density polyethylene (LDPE) at 190° C. is 5.1 g/10 min to 6.9 g/10 min.

9. The coaxial cable for nuclear power plants of claim 1, wherein insulation resistance of the cable is 1 MΩ or higher after radiation aging of 70 Mrad is performed on the cable.

10. The coaxial cable for nuclear power plants of claim 9, wherein the insulation resistance of the cable after accelerated thermal aging equivalent to at least 20 years is performed on the cable is 1 MΩ or higher.

11. The coaxial cable for nuclear power plants of claim 10, wherein the insulation resistance of the cable after a bending test is performed so that the cable is bent to be smaller than 20 times a diameter of the cable and unfolded again is 1 MΩ or higher.

12. The coaxial cable for nuclear power plants of claim 11, wherein the insulation resistance of the cable after a voltage of 2.5 kVdc is applied for 5 minutes after the cable is immersed for one hour is 1 MΩ or higher.

13. The coaxial cable for nuclear power plants of claim 12, wherein a relative dielectric constant of the cable is maintained at a change rate ±10% compared to a non-aged cable, and a signal propagation speed is maintained at a change rate ±10% compared to the non-aged cable.
